(19) United States
(12) Patent Application Publication
(10) Pub. No.: US 2004/0016773 A1
(43) Pub. Date: Jan. 29, 2004

(54) Fluid dispenser

(75) Inventor: John Wagner, Cheshire (GB)

Correspondence Address: SALTER & MICHAELSON, THE HERITAGE BUILDING, 321 SOUTH MAIN STREET, PROVIDENCE, RI, 029037128

(73) Assignee: PZ Cussons (International) Limited

(21) Appl. No.: 10/390,568

(22) Filed: Mar. 17, 2003

(30) Foreign Application Priority Data
Mar. 18, 2002 (GB) 0206343.6

(51) Int. Cl. B67D 5/52

(52) U.S. Cl. 222/137; 222/145.6

(57) ABSTRACT

A fluid dispenser (11) for delivering fluids from at least two separate reservoirs has a dispensing arrangement comprising a reservoir outlet (17, 18) from each of the reservoirs. Each reservoir outlet (17, 18) directs the flow of fluid from their respective reservoir towards a baffle (22) located between the outlets (17, 18). The fluid is dispensed in a single stream from a discharge aperture (19).

The present invention relates to a fluid dispenser. By fluid we mean any mobile substance such as a liquid, gas, cream or gel, although the present invention has particular, but not exclusive, application in the field of personal care products such as bath liquids, shower gels or cosmetic creams.

It is common to dispense products from flexible containers by either pouring low viscosity products or compressing or squeezing the walls of the container for higher viscosity creams or gels. For example, various mobile products such as shower gels and creams are commonly dispensed from bottles, tubes or film packs in this way.

For a dual product system, where both products need to be kept apart in separate compartments before delivery and intimate contact is required after delivery, it is difficult to place the two orifices close enough together to obtain mixing. This can also lead to cross contamination of the products by sucking back of the mixture into the individual compartments. Separated orifices need to be angled towards each other in order to achieve intimate contact on delivery and prevent contamination.

The problem in achieving this direction delivery with a viscous product, such as a gel is demonstrated by Pouseuille's law, which states that the pressure needed to dispense a fixed volume of liquid through a fixed orifice size increases with the viscosity of the product. This law has two implications to product delivery:

1. For a higher viscosity product, insufficient pressure is developed by squeezing to direct the two product flows resulting in two separate product streams.

2. For low viscosity products poured from a dual neck bottle, the force of gravity is insufficient to deflect the product flow.

The present invention has been made from a consideration of this problem.

According to the present invention there is provided a fluid dispenser for delivering fluids from at least two separate reservoirs, wherein the fluid dispenser has a dispensing arrangement comprising an outlet from each of the reservoirs, which reservoir outlets direct the flow of fluid from their respective reservoir towards a baffle located between the said reservoir outlets.

On leaving the dispenser the fluids that are dispensed are delivered in intimate contact in a single stream, not two separate streams. The invention has particular, but not exclusive, application to the dispensing of liquids, creams, or gels with a viscosity of 100,000 cps or less measured on a Brookfield viscometer (model No. RDVI1, C spindle 4 speed 20) at room temperature (20° C.). The products need to be kept apart and combine into a single stream only on dispensing which then, in a preferred embodiment of the invention, brings about mixing or starts a chemical reaction. The mixed product would have particular, but not exclusive, application as a personal cleansing composition.

In a preferred embodiment of the invention the said fluids are each dispersed via reservoir outlets that face the baffle. These outlets both meter and direct the flow of products towards the baffle. The baffle may be straight, for example for higher viscosity fluids, or curved to allow better sealing, for example where lower viscosity fluids are used.

The fluid preferably exits the dispenser via a discharge aperture. The discharge aperture is ideally larger than the combined area of the reservoir outlets. This provides a “siphon break” in the fluid flows and further prevents sucking back either mixed fluids or individual fluids into the wrong reservoir. The baffle ideally extends to the mouth of the discharge aperture, which is preferably located at the end of a neck.

To provide even further mixing of the two fluids after delivery without giving rise to sucking back, a mixing device can be fixed at the discharge aperture; i.e. after the dual reservoir outlets and baffle plate. This mixing device can be a flexible diaphragm, with a slit or multi-slit orifice arranged in a cross or star pattern, or a solid flow deflector. This device causes turbulence in the discharge products to give a marked effect on mixing the products or the speed of chemical reaction. Ideally this mixture device is in the form of a cap over a bottle neck, with said slit arrangement being provided in the cap.

In order that the present invention may be more readily understood it will be described by way of example only with reference to the accompanying drawings in which:

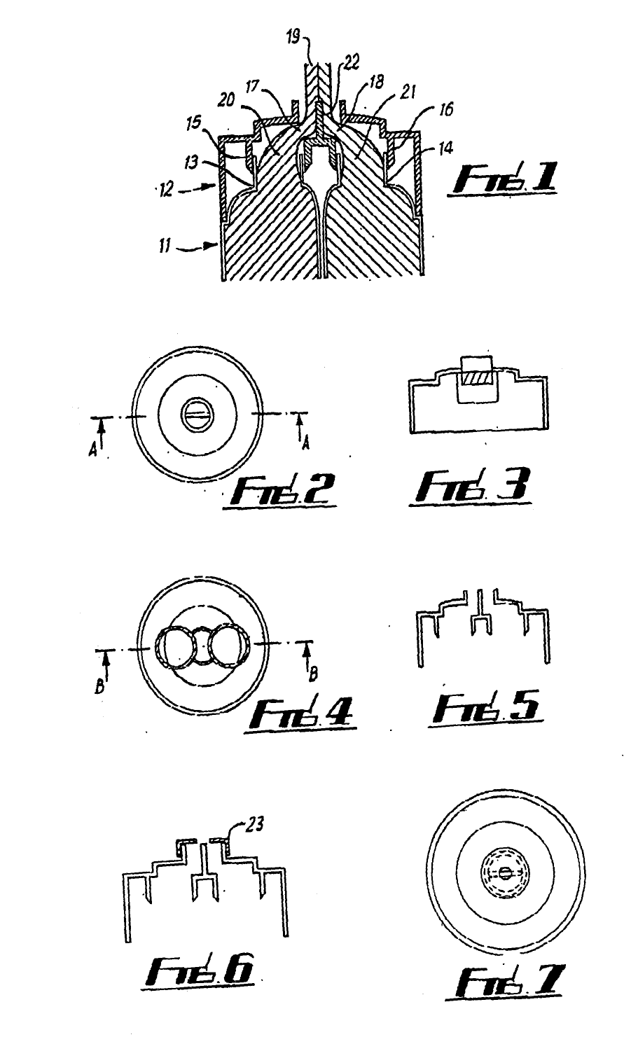

FIG. 1 is a diagrammatic cross section through part of one fluid dispenser in accordance with the present invention;

FIG. 2 is a plan view of the fluid dispenser of FIG. 1;

FIG. 3 is a section along the line A-A of FIG. 2;

FIG. 4 is an underplan view of the fluid dispensing cap of FIG. 1;

FIG. 5 is a section along the line B-B of FIG. 4;

FIG. 6 shows a further embodiment of a fluid dispensing cap in accordance with the present invention; and

FIG. 7 is a plan view of the cap of FIG. 6.

Referring to FIGS. 1 to 5 a two chambered bottle 11 made of flexible plastics, only part of which is shown, is secured to a cap 12. The multi-chambered bottle would conventionally be made in two separately moulded parts which are secured together or blown from a single parison.

The two individual parts of the bottle each have a neck 13,14 which is secured to a corresponding closure 15,16 for that neck, and formed as an integral part of the cap 12. Each individual part contains a reservoir of fluid, which fluids when mixed together would react. However, the fluids are stored separately in said individual bottle parts. A metering reservoir outlet 17,18 is provided in each closure, the two metering outlets 17,18 both facing radially inwardly, i.e. they are located on the side of each closure and face inwardly. The two metering outlets facilitate the dispensing of the fluids in a manner so as to direct the dispensed fluids towards each other, i.e. in a direction roughly perpendicular to the direction of travel of fluid through a discharge aperture 19 from the fluid dispenser.

On squeezing the flexible walls of the dispenser, product from the individual reservoirs in the individual bottle parts exits the reservoir metering outlets 17,18. Initial mixing of the two fluids 20,21 is prevented by a baffle 22 located between the two outlets 17,18. The two fluid products are thus delivered via the metering outlets 17,18 and directed towards each other at right angles onto opposing faces of the dividing baffle plate 22 located in the discharge aperture 19. Both separate product streams then flow down the baffle plate and combine together into a single stream on exit via discharge aperture 19.

Preferably the cross-sectional area of the discharge aperture 19 is larger than the combined cross-sectional area of the metering outlets 17,18. This arrangement breaks the continuous product stream very much reducing the risk of cross contamination by sucking back.

Thus on squeezing the walls of the bottle parts, for a viscous liquid or pouring a thinner liquid by gravity, the dispenser described above delivers both products in intimate contact immediately on dispensing; i.e. in a single continuous stream rather than separate streams. The dispenser also prevents cross-contamination from one side to another as a consequence of sucking back and dispenses both products simultaneously in approximately the same volume.

To further mix the products FIGS. 6 and 7 show a cap 23, fitted over the dispenser neck, having in the top thereof the discharge aperture. The discharge aperture is in the form of a slit or other arrangement of one or more perforations therethrough. This induces turbulence into the combined product flow and hence enhances mixing or accelerates any chemical reaction, resulting from a mixing of the individual fluid products from the two individual bottle parts.

It is to be understood that the above described embodiment is by way of illustration only. Many modifications and variations are possible.

1. A fluid dispenser for delivering fluids from at least two separate reservoirs, wherein the fluid dispenser has a dispensing arrangement comprising an outlet from each of the reservoirs, which reservoir outlets direct the flow of fluid from their respective reservoir towards a baffle located between the reservoir outlets.

2. A fluid dispenser as claimed in claim 1, wherein the baffle is straight.

3. A fluid dispenser as claimed in claim 1, wherein the baffle is curved.

4. A fluid dispenser as claimed in claim 1, wherein the fluids exit the dispenser via a discharge aperture.

5. A fluid dispenser as claimed in claim 4, wherein the discharge aperture has a larger cross-sectional area than the combined cross-sectional area of the reservoir outlets.

6. A fluid dispenser as claimed in claim 4, wherein the bottle extends to the mouth of the discharge aperture.

7. A fluid dispenser as claimed in claim 4, wherein the discharge aperture is provided at a mouth of a neck in the fluid dispenser.

8. A fluid dispenser as claimed in claim 4, wherein a diaphragm is provided over the discharge aperture, at least one perforation being provided through the diaphragm.
